(19) United States
(12) Patent Application Publication
(10) Pub. No.: US 2026/0111509 A1
(43) Pub. Date: Apr. 23, 2026

(54) DATA PROCESSING METHOD, DATA DIAGNOSIS METHOD, AND DATA PROCESSING PROGRAM

(71) Applicant: MITSUBISHI HEAVY INDUSTRIES, LTD., Tokyo (JP)

(72) Inventors: Ichiro NAGANO, Tokyo (JP); Mayumi SAITO, Tokyo (JP); Kuniaki AOYAMA, Hyogo (JP); Keiji EGUCHI, Tokyo (JP)

(21) Appl. No.: 19/116,054

(22) PCT Filed: Aug. 29, 2023
(86) PCT No.: PCT/JP2023/031280

§ 371 Date: Mar. 27, 2025

(30) Foreign Application Priority Data
Oct. 17, 2022 (JP) 2022-166013

(51) Int. Cl. G06F 17/11; G06F 17/15

(52) U.S. Cl. CPC G06F 17/11; G06F 17/15

(57) ABSTRACT

The present method relates to a data processing method for processing data for calculating a Mahalanobis distance. The present method calculates an objective function for linearizing a combination of items included in unit space data, and calculates coordinate transformation parameters for performing coordinate transformation of the unit space data for each item, in order to minimize the objective function. Then, the calculated coordinate transformation parameters are used to perform coordinate transformation of the unit space data for each item. The unit space data that underwent coordinate transformation is standardized for each item.

### TECHNICAL FIELD

The present disclosure relates to a data processing method, a data diagnosis method, and a data processing program.

The present application claims priority based on Japanese Patent Application No. 2022-166013 filed in Japan on Oct. 17, 2022, the contents of which are incorporated herein by reference.

### BACKGROUND ART

As a method of determining normality/abnormality in consideration of a correlation between items (variables), a Mahalanobis-Taguchi (MT) method is known. In the MT method, for a signal space that is a population serving as a determination target, a Mahalanobis distance quantitatively indicating a degree of deviation from a unit space that is a normal population is calculated as an index. An increase in the Mahalanobis distance means that the signal space deviates from the unit space, and the Mahalanobis distance can be treated as a measure for determining normality/abnormality in the determination target that is difficult to quantify.

The population handled by the MT method is assumed to have a normal distribution. However, in general, the population includes an item having a different unit or an item having a non-normal distribution. In the MT method, in order to handle the population including such various items, standardization processing is performed on the unit space or the signal space (for example, PTL 1). For example, an item X′ obtained by standardizing an item X is obtained by the following equation using an average value Xavg of the item X and a standard deviation σ thereof.

$${X}^{′} = ( X - Xavg ) / σ \qquad ( 1 )$$

The standardized item X′ has an average value of “zero” and a variance of “1”.

### CITATION LIST

### Patent Literature

[PTL 1] Japanese Unexamined Patent Application Publication No. 2012-252556

### SUMMARY OF INVENTION

### Technical Problem

The above MT method is a linear analysis method on the premise that the item to be handled follows the normal distribution. For this reason, normality/abnormality can be reliably determined in a case where a variable having high linearity is targeted, but there is a concern that the reliability may be lowered in a case where an item having high nonlinearity or an item having the non-normal distribution is included.

At least one embodiment of the present disclosure has been made in view of the above circumstances, and an object of the present disclosure is to provide a data processing method, a data diagnosis method, and a data processing program that can perform reliable abnormality determination even in a case of handling a population including an item having high nonlinearity or an item having a non-normal distribution.

### Solution to Problem

In order to solve the above problems, a data processing method according to at least one embodiment of the present disclosure is a data processing method of processing data for calculating a Mahalanobis distance, the method including
a step of calculating an objective function for linearizing a combination of respective items included in the unit space data,
a step of calculating a coordinate transformation parameter for performing, for each item, a coordinate transformation on the unit space data to minimize the objective function,
a step of performing, for each item, the coordinate transformation on the unit space data using the coordinate transformation parameter, and
a step of standardizing, for each item, the unit space data subjected to the coordinate transformation.

In order to solve the above problems, a data diagnosis method according to at least one embodiment of the present disclosure includes
the data processing method according to at least one embodiment of the present disclosure,
a step of performing a coordinate transformation on signal space data using the coordinate transformation parameter,
a step of calculating the Mahalanobis distance as a degree of deviation of the signal space data after the coordinate transformation from the unit space data after the coordinate transformation, and
a step of diagnosing soundness of the signal space data based on the Mahalanobis distance.

In order to solve the above problems, a data processing program according to at least one embodiment of the present disclosure is a data processing program for processing data for calculating a Mahalanobis distance, the data processing program causing a computer device to execute
a step of calculating an objective function for linearizing a combination of respective items included in the unit space data,
a step of calculating a coordinate transformation parameter for performing, for each item, a coordinate transformation on the unit space data to minimize the objective function,
a step of performing, for each item, the coordinate transformation on the unit space data using the coordinate transformation parameter, and
a step of standardizing, for each item, the unit space data subjected to the coordinate transformation.

### Advantageous Effects of Invention

According to at least one embodiment of the present disclosure, it is possible to provide the data processing method, the data diagnosis method, and the data processing program that can perform the reliable abnormality determination even in a case of handling the population including the item having high nonlinearity or the item having a non-normal distribution.

### BRIEF DESCRIPTION OF DRAWINGS

FIG. 1 is an overall configuration diagram of a plant monitoring device according to an embodiment.

FIG. 2 is an example of signal space data stored in a signal space file of FIG. 1.

FIG. 3 is an example of unit space data stored in a unit space file of FIG. 1.

FIG. 4 is an example of a unit space corresponding to the unit space data.

FIG. 5 is a flowchart showing a plant monitoring method implemented by the plant monitoring device of FIG. 1.

FIG. 6 is a flowchart showing a data processing method according to an embodiment.

FIG. 7 is a flowchart showing a method of calculating an objective function in step S201 of FIG. 6.

FIG. 8 is a table showing a combination of respective evaluation items used for calculating the objective function.

FIG. 9 is a flowchart showing another method of calculating the objective function in step S201 of FIG. 6.

FIG. 10 is a graph showing the unit space corresponding to a result of data processing on the unit space data shown in FIG. 4.

### DESCRIPTION OF EMBODIMENTS

Hereinafter, some embodiments of the present invention will be described with reference to accompanying drawings. Meanwhile, configurations described in the embodiments or shown in the drawings are not intended to limit the scope of the invention, and are merely description examples.

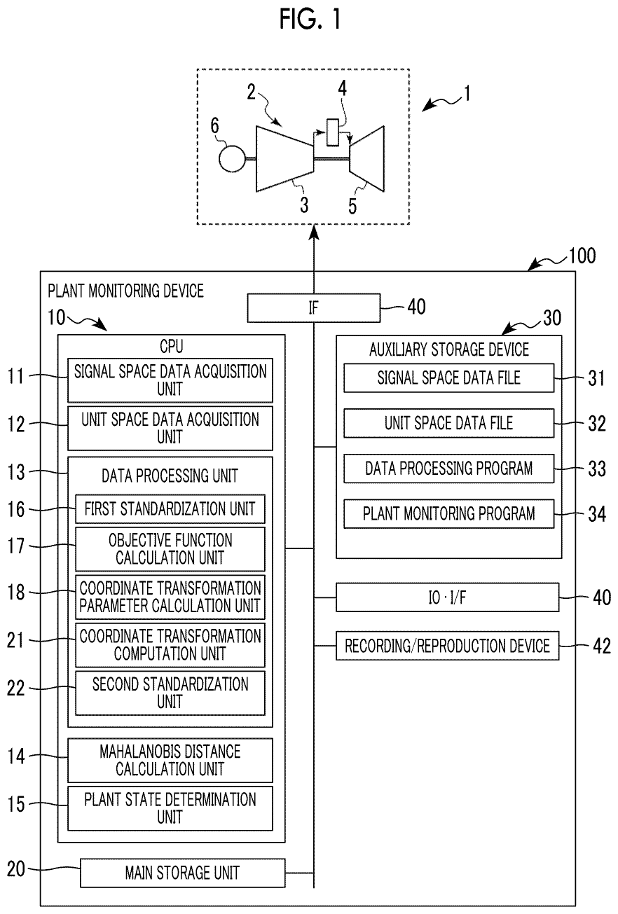

FIG. 1 is an overall configuration diagram of a plant monitoring device 100 according to an embodiment. The plant monitoring device 100 is to monitor an operating state of a gas turbine power plant 1. The gas turbine power plant 1 includes a gas turbine 2 and a generator 6 that generates power by driving the gas turbine 2. The gas turbine 2 includes a compressor 3 that generates compressed air, a combustor 4 that mixes a fuel with the compressed air and combusts the mixture to generate combustion gas, and a turbine 5 that is rotationally driven by the combustion gas. A rotor of the turbine 5 is connected to the generator 6 via the compressor 3, and the generator 6 generates the power by rotation of the rotor.

The plant monitoring device 100 acquires a state amount for each of a plurality of evaluation items of the gas turbine power plant 1, and determines whether or not the operating state of the gas turbine power plant 1 is normal based on the state amounts. The plant monitoring device 100 monitors the operating state of the gas turbine power plant 1 using a Mahalanobis-Taguchi method (hereinafter referred to as “MT method” as appropriate). Examples of the evaluation items of the gas turbine power plant 1 include a gas turbine output, a cavity temperature at a plurality of locations between a turbine rotor and a stationary portion, a blade pass temperature at a plurality of locations in a circumferential direction at a gas outlet of the turbine, a displacement amount at a plurality of locations in the circumferential direction of the turbine rotor, and an opening degree of various valves provided in the gas turbine. Various types of state amount detection means such as sensors are provided in the gas turbine power plant 1 to detect the state amounts.

The plant monitoring device 100 is configured of a computer device, and includes a CPU 10 that executes various types of computation processing, a main storage device 20 such as a RAM that serves as a work area or the like of the CPU 10, an auxiliary storage device 30 such as a hard disk drive device that stores various types of data, programs, or the like, an input/output interface 40 of various types of state amount detection means or an input/output device, such as a keyboard, a mouse, a touch panel, or a display (not shown), of the gas turbine power plant 1, and a recording/reproduction device 42 that records or reproduces data on a disk type storage medium such as a CD or a DVD.

The auxiliary storage device 30 stores in advance various programs including a plant monitoring program 34, a data processing program 33, an OS program, and the like for causing the computer to function as the plant monitoring device 100. The various programs including the data processing program 33 and the plant monitoring program 34 are incorporated into the auxiliary storage device 30 from the disk type storage medium via the storage/reproduction device 42.

The programs may be incorporated into the auxiliary storage device 30 from a portable memory, such as a flash memory, or an external device via a communication device (not shown).

Further, the auxiliary storage device 30 is further provided with the following files in an execution process of the data processing program 33 and the plant monitoring program 34. That is, the auxiliary storage device 30 is provided with a signal space file 31 that stores data of the state amount for each of the plurality of evaluation items of the gas turbine power plant 1 (signal space data), and a unit space file 32 that stores data of a unit space serving as a reference in a case where the operating state of a plant is determined (unit space data).

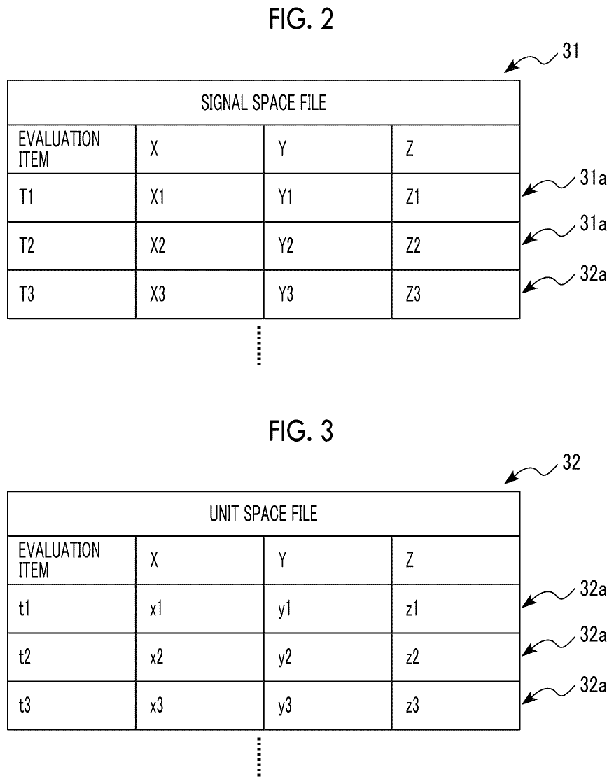

FIG. 2 is an example of signal space data 31a stored in the signal space file 31 of FIG. 1. As shown in FIG. 2, in the execution process of the data processing program 33 and the plant monitoring program 34, the signal space file 31 stores the signal space data 31a, which is a set of state amounts X, Y, and Z for each of the plurality of evaluation items of the gas turbine power plant 1, in time series for each of acquisition time points T1, T2, . . . of the state amounts.

FIG. 3 is an example of the unit space data 32a stored in the unit space file 32 of FIG. 1. As shown in FIG. 3, in the execution process of the data processing program 33 and the plant monitoring program 34, the unit space file 32 stores the unit space data 32a, which is a set of the state amounts X, Y, and Z for each of the plurality of evaluation items, to correspond to the signal space data 31a.

The CPU 10 functionally includes a signal space data acquisition unit 11 that acquires the signal space data 31a stored in the signal space file 31, a unit space data acquisition unit 12 that acquires the unit space data 32a stored in the unit space file 32, a data processing unit 13 that implements data processing on the signal space data 31a and the unit space data 32a, a Mahalanobis distance calculation unit 14 that obtains a Mahalanobis distance using data subjected to the data processing by the data processing unit 13, and a plant state determination unit 15 that diagnoses soundness of the operating state of the gas turbine power plant 1 according to whether or not the Mahalanobis distance obtained by the Mahalanobis distance calculation unit 14 is within a predetermined threshold value.

Among the functional components of the CPU 10 described above, the data processing unit 13 functions with the execution of the data processing program 33, which is stored in the auxiliary storage device 30, by the CPU 10. Further, the signal space data acquisition unit 11, the unit space data acquisition unit 12, the Mahalanobis distance calculation unit 14, and the plant state determination unit 15 function with the execution of the plant monitoring program 34, which is stored in the auxiliary storage device 30, by the CPU 10.

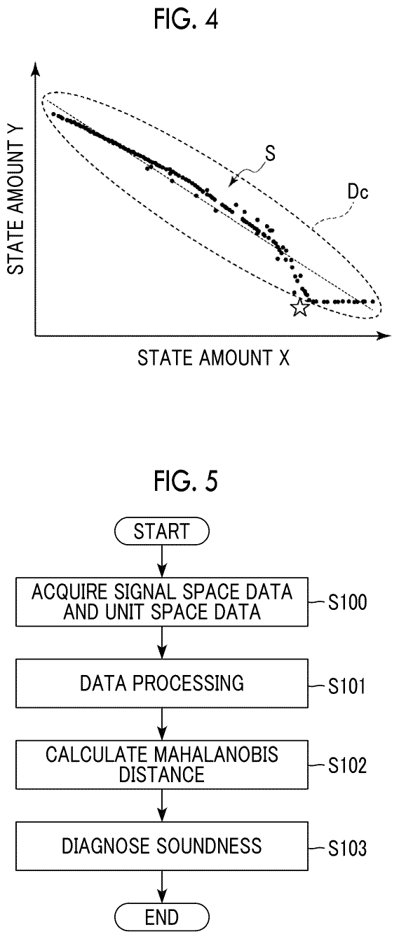

Next, a monitoring operation of the plant monitoring device 100 of the present embodiment will be described. The plant monitoring by the plant monitoring device 100 uses the MT method as described above. A basic content of a plant monitoring method using the MT method will be described with reference to FIG. 4. FIG. 4 is an example of a unit space S corresponding to the unit space data 32a.

Here, for example, an output of the generator 6 of the gas turbine power plant 1 and an intake air temperature of the compressor 3 thereof are respectively set as the state amounts X and Y, which are the evaluation items (in this example, for convenience of description, a case where there are two state amounts X and Y as the evaluation items is described, but there may be three or more state amounts by including a state amount Z or the like). In the MT method, with reference to the unit space S corresponding to the unit space data 32a that is a set of bundles serving as a reference for the state amounts, a Mahalanobis distance D is obtained as an evaluation index for whether or not the signal space data 31a indicating the operating state is abnormal. The Mahalanobis distance D indicates a larger value as a degree of abnormality of a monitoring target becomes larger. In the MT method, determination is made whether or not the operating state of the plant is abnormal, according to whether or not the Mahalanobis distance D is within a threshold value Dc set in advance.

In FIG. 4, a solid line surrounding the unit space S indicates a position where the Mahalanobis distance D is the threshold value Dc.

However, as indicated by a star mark in FIG. 4, the unit space data 32a shows nonlinear behavior by being bent. The above MT method is a linear analysis method on the premise that the item to be handled follows the normal distribution. For this reason, normality/abnormality can be reliably determined in a case where an evaluation item having high linearity is targeted, but there is a concern that the reliability may be lowered in a case where such an item having high nonlinearity or an item having a non-normal distribution is included. Such problems can be suitably solved by the data processing described below.

FIG. 5 is a flowchart showing the plant monitoring method implemented by the plant monitoring device 100 of FIG. 1.

First, the signal space data acquisition unit 11 acquires the signal space data 31a stored in the signal space file 31 (step S100). Further, the unit space data acquisition unit 12 acquires the unit space data 32a stored in the unit space file 32 (step S101).

Subsequently, the data processing unit 13 implements the data processing on the signal space data 31a and the unit space data 32a, which are acquired in step S100 (step S102). In general, the MT method is a linear analysis method on the premise that the evaluation item to be handled follows the normal distribution. For this reason, in a case where the evaluation item having high nonlinearity or the evaluation item having the non-normal distribution is included, there is a concern that the reliability may be lowered. Although details of the data processing implemented in step S4 will be described below, with the implementation of the data processing, it is possible to improve the linearity of the evaluation item or to bring the distribution of the evaluation item closer to the normal distribution with a coordinate transformation on the signal space data 31a and the unit space data 32a used for calculating the Mahalanobis distance D.

Subsequently, the Mahalanobis distance calculation unit 14 calculates the Mahalanobis distance D by using the signal space data 31a and the unit space data 32a subjected to the data processing (step S103). The plant state determination unit 15 compares the Mahalanobis distance D calculated in step S103 with the threshold value Dc to determine the soundness of the operating state of the plant (step S104).

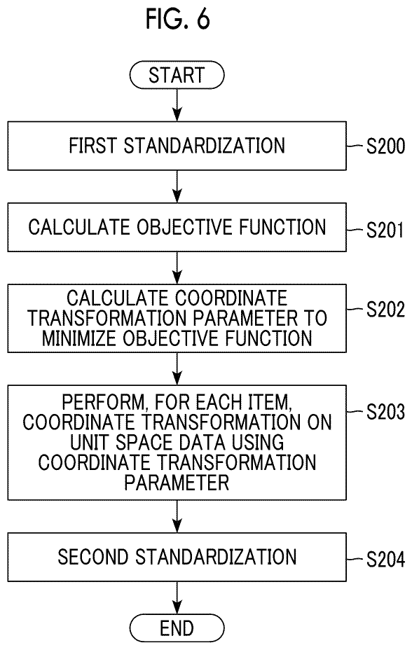

Subsequently, a specific content of the data processing method implemented in step S102 of FIG. 5 will be described. FIG. 6 is a flowchart showing the data processing method according to an embodiment. The data processing method is realized as a function of the data processing unit 13 with the execution of the data processing program 33. In this case, the data processing unit 13 functionally includes a first standardization unit 16, an objective function calculation unit 17, a coordinate transformation parameter calculation unit 18, a coordinate transformation computation unit 21, and a second standardization unit 22.

First, the first standardization unit 16 standardizes the unit space data 32a acquired in step S100 (step S200). In general, each of the state amounts X, Y, and Z, which are the plurality of evaluation items included in the unit space data 32a, has a different unit or average value. In the standardization implemented in step S200, in order to compare the state amounts X, Y, and Z equally, the transformation is performed such that the state amount has the average value of “zero” and a standard deviation of “1”. For example, the state amount X, which is one of the evaluation items included in the unit space data 32a, is standardized by the following equation using an average value Xavg of the state amount X and a standard deviation σ thereof (the same applies to other state amounts Y and Z).

$${X}^{′} = ( X - Xavg ) / σ \qquad ( 2 )$$

Subsequently, the objective function calculation unit 17 calculates an objective function fx for linearizing a combination of respective evaluation items included in the unit space data 32a (step S201). The coordinate transformation parameter calculation unit 18 calculates a coordinate transformation parameter for minimizing the objective function fx calculated in step S201 (step S202).

In step S202, the coordinate transformation parameter included in any coordinate transformation equation can be used. However, as one aspect, in a case where a SHASH transformation is used, the state amount X′, which is the evaluation item, is transformed by the following expression using the coordinate transformation parameters δ and ε (“X″” is the state amount X′ after the coordinate transformation).

$${X}^{″} = sinh ( δ * asinh {X}^{′} - ε ) \qquad ( 3 - 1 )$$

$${X}^{′} = sinh ( δ * asinh ( \frac{( X - Xavg}{σ} ) - ε ) \qquad ( 3 - 2 )$$

Further, in another aspect, a Yeo-Johnson transformation can be used as the coordinate transformation. In this case, the state amount X′, which is the evaluation item, is transformed by the following equation using a coordinate transformation parameter λ (“X″” is the state amount X′ after the coordinate transformation).

$${x}_{\text{?}}^{′} = \{ \begin{matrix}[ {( {x}_{n} + 1 )}^{{λ}_{1}} - 1 ] / {λ}_{1} & if {λ}_{1} \neq 0 , {x}_{\text{?}} \geq 0 \\ ln ( {x}_{ij} + 1 ) & if {λ}_{\text{?}} = 0 , {x}_{\text{?}} \geq 0 \\ - [ {( - {x}_{\text{?}} + 1 )}^{2 {λ}_{\text{?}}} - 1 ] / ( 2 - {λ}_{\text{?}} ) & if {λ}_{\text{?}} \neq 2 , {x}_{ij} < 0 \\ - ln ( - {x}_{\text{?}} + 1 ) & if {λ}_{\text{?}} = 2 , {x}_{\text{?}} < 0\end{matrix} \qquad ( 4 )$$

$$\text{?} \text{indicates text missing or illegible when filed}$$

Further, in another aspect, a Boltzmann transformation, a double Boltzmann transformation, a broken line transformation, or the like can be used as the coordinate transformation. Any one of the exemplified coordinate transformations may be used alone, or two or more of the coordinate transformations may be used in combination.

Subsequently, the coordinate transformation computation unit 21 performs, for each item, the coordinate transformation on the unit space data 32a using the coordinate transformation parameter calculated in step S202 (step S203). The second standardization unit 22 standardizes, for each item, the unit space data 32a subjected to the coordinate transformation in step S203 (step S204). The second standardization implemented in step S204 is substantially the same as the first standardization implemented in step S200.

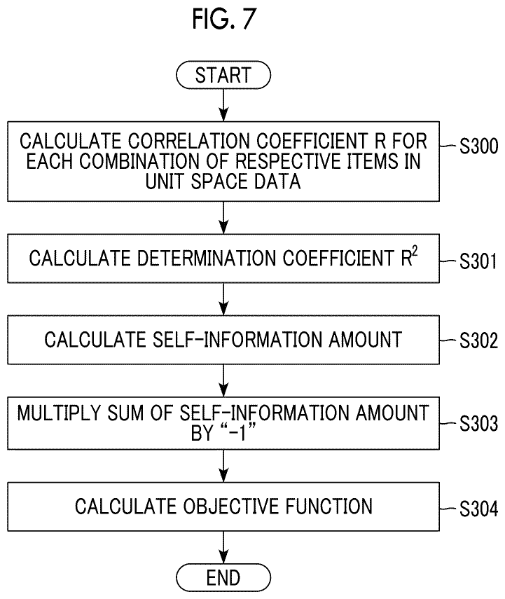

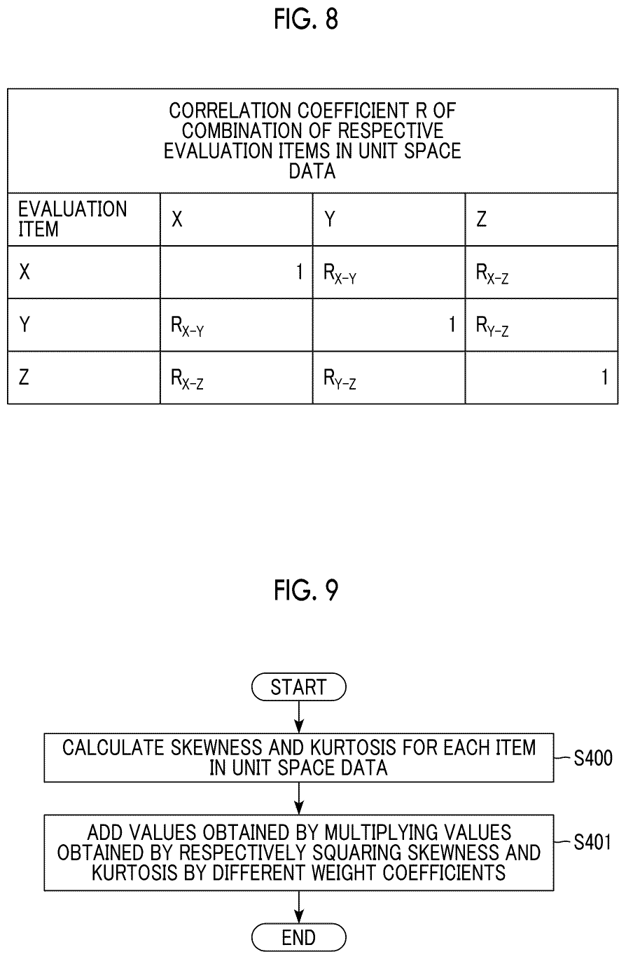

Some specific calculation examples of the objective function fx in step S201 will be described. FIG. 7 is a flowchart showing a method of calculating the objective function fx in step S201 of FIG. 6, and FIG. 8 is a graph showing a combination of respective evaluation items used for calculating the objective function fx.

First, a correlation coefficient R for each combination of respective evaluation items, which are included in the unit space data 32a acquired in step S100, is calculated (step S300). The example of FIG. 8 shows the correlation coefficient R for each combination of the state amounts X, Y, and Z, which are three evaluation items. Specifically, a correlation coefficient Rx-y corresponding to a combination of the state amounts X and Y, a correlation coefficient Rx-z corresponding to a combination of the state amounts X and Z, and a correlation coefficient Ry-z corresponding to a combination of the state amounts Y and Z are shown.

Subsequently, a determination coefficient R² is calculated based on each correlation coefficient R calculated in step S300 (step S301), and a self-information amount is further calculated based on the determination coefficient R² (step S302). The self-information amount is a concept of information theory, and is a measure representing how unlikely an event occurs in a case where the event occurs. The self-information amount can also be regarded as a measure of how much information the event essentially has. In the present embodiment, a self-information amount I is defined by the following equation (in a case where the determination coefficient R² approaches “1” (in a case of linearization), the self-information amount I is maximized).

$$I = - {log}_{10} ( 1 - {R}^{2} ) \qquad ( 5 )$$

The objective function fx is obtained by multiplying a sum of the self-information amount calculated in step S303 by “−1” (step S303).

Further, FIG. 9 is a flowchart showing another method of calculating the objective function fx in step S201 of FIG. 6.

First, the objective function calculation unit 17 calculates a skewness and a kurtosis for each evaluation item included in the unit space data 32a acquired in step S100 (step S400). Specifically, the skewness and the kurtosis are obtained by the following equations.

$$Skewness = \frac{1}{n} {\sum }_{i = 1}^{n} {( \frac{{x}_{\text{?}}^{\text{?}} - x}{\text{?}} )}^{3} \qquad ( 6 - 1 )$$

$$Kurtosis = \frac{1}{n} {\sum }_{i = 1}^{n} {( \frac{{x}_{\text{?}}^{\text{?}} - \text{?}}{\text{?}} )}^{4} - 3 \qquad ( 6 - 2 )$$

$$\text{?} \text{indicates text missing or illegible when filed}$$

Subsequently, the objective function calculation unit 17 adds values obtained by multiplying values obtained by respectively squaring the skewness and the kurtosis, which are calculated in step S400, by different weight coefficients to obtain the objective function fx (step S401). Specifically, the objective function fx is obtained by the following equation.

$$f x = 0.8 \times {( kurtosis )}^{2} + 0.2 \times {( skewness )}^{2} \qquad ( 7 )$$

With the calculation of the coordinate transformation parameter to minimize the objective function fx calculated based on the skewness and the kurtosis in this manner, it is possible to obtain the coordinate transformation parameter for bringing the skewness and the kurtosis of each evaluation item close to zero, that is, for bringing the distribution of each evaluation item close to the normal distribution.

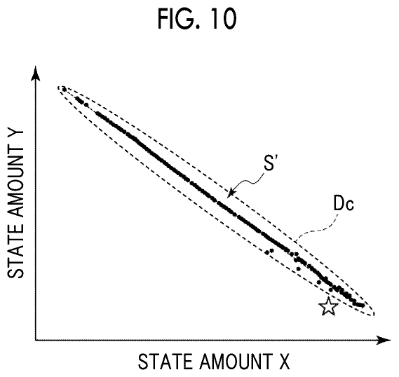

According to each of the above embodiments as described above, with the data processing on the signal space data 31a and the unit space data 32a for calculating the Mahalanobis distance D, the coordinate transformation is performed on the signal space data 31a and the unit space data 32a including the evaluation item having high nonlinearity and the evaluation item having the non-normal distribution. Accordingly, it is possible to improve the linearity of the signal space data 31a and the unit space data 32a or to bring the distribution thereof close to the normal distribution. For example, FIG. 10 is a graph showing a unit space S′ corresponding to a result of the data processing on the unit space data 32a shown in FIG. 4. The behavior that is nonlinearly shown by being bent as indicated by the star mark in FIG. 4 is improved to be straight (that is, linear) as shown in FIG. 10. As a result, with the calculation of the Mahalanobis distance D based on the signal space data 31a and the unit space data 32a subjected to the coordinate transformation in this manner, it is possible to diagnose the soundness with high accuracy.

Further, it is possible to replace the components in the embodiment described above with well-known components as appropriate within the scope not departing from the concept of the present disclosure, and the embodiments described above may be combined with each other as appropriate.

The contents described in each embodiment are understood as follows, for example.

(1) A data processing method according to one aspect is
a data processing method of processing data for calculating a Mahalanobis distance, the method including
a step of calculating an objective function for linearizing a combination of respective items included in unit space data,
a step of calculating a coordinate transformation parameter for performing, for each item, a coordinate transformation on the unit space data to minimize the objective function,
a step of performing, for each item, the coordinate transformation on the unit space data using the coordinate transformation parameter, and
a step of standardizing, for each item, the unit space data subjected to the coordinate transformation.

According to the aspect (1), the objective function for linearizing the combination of respective items included in the unit space data is calculated, and the coordinate transformation parameter for linearizing the combination of respective items included in the unit space data is calculated to minimize the objective function. With the coordinate transformation on the unit space data using the coordinate transformation parameter calculated in this manner, even in a case where the unit space data includes the item having high nonlinearity or the item that does not follow the non-normal distribution, it is possible to linearize the unit space data. In the MT method, with the use of the unit space data linearized in this manner, it is possible to diagnose the soundness with high reliability based on a population including the item having high nonlinearity.

(2) In another aspect, in the aspect (1),
the step of calculating the objective function includes
a step of calculating a correlation coefficient for each combination,
a step of calculating a determination coefficient based on the correlation coefficient,
a step of calculating a self-information amount based on the determination coefficient, and
a step of multiplying a sum of the self-information amount by −1 to obtain the objective function.

According to the aspect (2), with the multiplication of the self-information amount based on the determination coefficient calculated from the correlation coefficient for each combination of respective items included in the unit space data by −1, the objective function for linearizing the combination of respective items included in the unit space data is suitably obtained.

(3) In another aspect, in the aspect (1),
the step of calculating the objective function includes
a step of calculating a skewness and a kurtosis for each item, and
a step of adding values obtained by multiplying values obtained by respectively squaring the skewness and the kurtosis by different weight coefficients to obtain the objective function.

According to the aspect (3), with the addition of the values obtained by multiplying values obtained by respectively squaring the skewness and the kurtosis for each item included in the unit space data by different weight coefficients, the objective function for linearizing the combination of respective items included in the unit space data is suitably obtained.

(4) In another aspect, in any one aspect of (1) to (3),
the coordinate transformation includes at least one of a SHASH transformation, a Yeo-Johnson transformation, a Boltzmann transformation, a double Boltzmann transformation, or a broken line transformation.

According to the aspect (4), with the calculation of the coordinate transformation parameter used in the transformation methods to minimize the objective function, it is possible to suitably linearize the combination of respective items included in the unit space data.

For the coordinate transformation, any one of the transformation methods may be employed, a combination of at least two of the transformation methods may be employed, or the same method may be employed a plurality of times.

(5) In another aspect, in any one aspect of (1) to (4),
the method further includes a step of standardizing the unit space data for each item,
in which the objective function for linearizing the combination of respective items, which are included in the standardized unit space data, is calculated in the step of calculating the objective function.

According to the aspect of (5), the objective function is calculated using the standardized unit space data in advance. Accordingly, it is possible to effectively reduce the computation burden related to the calculation of the objective function.

(6) A data diagnosis method according to one aspect includes
the data processing method according to any one aspect of (1) to (3),
a step of performing a coordinate transformation on signal space data using the coordinate transformation parameter,
a step of calculating the Mahalanobis distance as a degree of deviation of the signal space data after the coordinate transformation from the unit space data after the coordinate transformation, and
a step of diagnosing soundness of the signal space data based on the Mahalanobis distance.

According to the aspect (6), the signal space data serving as a diagnosis target is also subjected to the coordinate transformation using the coordinate transformation parameter calculated to linearize the unit space data. That is, the unit space data and the signal space data are respectively subjected to the coordinate transformation using a common coordinate transformation parameter. With the calculation of the Mahalanobis distance based on the unit space and the signal space data subjected to the coordinate transformation in this manner, it is possible to diagnose the soundness with high reliability for a population including the item having high nonlinearity or the item having the non-normal distribution.

(7) A data processing program according to one aspect is
a data processing program for processing data for calculating a Mahalanobis distance, the data processing program causing a computer device to execute
a step of calculating an objective function for linearizing a combination of respective items included in unit space data,
a step of calculating a coordinate transformation parameter for performing, for each item, a coordinate transformation on the unit space data to minimize the objective function,
a step of performing, for each item, the coordinate transformation on the unit space data using the coordinate transformation parameter, and
a step of standardizing, for each item, the unit space data subjected to the coordinate transformation.

According to the aspect (7), the objective function for linearizing the combination of respective items included in the unit space data is calculated, and the coordinate transformation parameter for linearizing the combination of respective items included in the unit space data is calculated to minimize the objective function. With the coordinate transformation on the unit space data using the coordinate transformation parameter calculated in this manner, even in a case where the unit space data includes the item having high nonlinearity or the item that does not follow the non-normal distribution, it is possible to linearize the unit space data. In the MT method, with the use of the unit space data linearized in this manner, it is possible to diagnose the soundness with high reliability based on a population including the item having high nonlinearity.

### REFERENCE SIGNS LIST

1: gas turbine power plant
2: gas turbine
3: compressor
4: combustor
5: turbine
6: generator
10: CPU
11: signal space data acquisition unit
12: unit space data acquisition unit
13: data processing unit
14: Mahalanobis distance calculation unit
15: plant state determination unit
16: first standardization unit
17: objective function calculation unit
18: coordinate transformation parameter calculation unit
20: main storage device
21: coordinate transformation computation unit
22: second standardization unit
30: auxiliary storage device
31: signal space file
31a: signal space data
32: unit space file
32a: unit space data
33: data processing program
34: plant monitoring program
40: input/output interface
42: recording/reproduction device
100: plant monitoring device
D: Mahalanobis distance
Dc: threshold value

1. A data processing method of processing data for calculating a Mahalanobis distance, the method comprising:
a step of calculating an objective function for linearizing a combination of respective items included in the unit space data;
a step of calculating a coordinate transformation parameter for performing, for each item, a coordinate transformation on the unit space data to minimize the objective function;
a step of performing, for each item, the coordinate transformation on the unit space data using the coordinate transformation parameter; and
a step of standardizing, for each item, the unit space data subjected to the coordinate transformation.

2. The data processing method according to claim 1,
wherein the step of calculating the objective function includes
a step of calculating a correlation coefficient for each combination,
a step of calculating a determination coefficient based on the correlation coefficient,
a step of calculating a self-information amount based on the determination coefficient, and
a step of multiplying a sum of the self-information amount by −1 to obtain the objective function.

3. The data processing method according to claim 1,
wherein the step of calculating the objective function includes
a step of calculating a skewness and a kurtosis for each item, and
a step of adding values obtained by multiplying values obtained by respectively squaring the skewness and the kurtosis by different weight coefficients to obtain the objective function.

4. The data processing method according to claim 1,
wherein the coordinate transformation includes at least one of a SHASH transformation, a Yeo-Johnson transformation, a Boltzmann transformation, a double Boltzmann transformation, or a broken line transformation.

5. The data processing method according to claim 1, further comprising:
a step of standardizing the unit space data for each item,
wherein the objective function for linearizing the combination of respective items, which are included in the standardized unit space data, is calculated in the step of calculating the objective function.

6. A data diagnosis method comprising:
the data processing method according to claim 1;
a step of performing a coordinate transformation on signal space data using the coordinate transformation parameter;
a step of calculating the Mahalanobis distance as a degree of deviation of the signal space data after the coordinate transformation from the unit space data after the coordinate transformation; and
a step of diagnosing soundness of the signal space data based on the Mahalanobis distance.

7. A data processing program for processing data for calculating a Mahalanobis distance, the data processing program causing a computer device to execute:
a step of calculating an objective function for linearizing a combination of respective items included in the unit space data;
a step of calculating a coordinate transformation parameter for performing, for each item, a coordinate transformation on the unit space data to minimize the objective function;
a step of performing, for each item, the coordinate transformation on the unit space data using the coordinate transformation parameter, and
a step of standardizing, for each item, the unit space data subjected to the coordinate transformation.
